(19) United States
(12) Patent Application Publication
(10) Pub. No.: US 2013/0255484 A1
(43) Pub. Date: Oct. 3, 2013

(54) SYSTEM AND METHOD FOR CONTROL OF A STRIPPER TOWER

(71) Applicants: Rameshwar S. Hiwale, Knoxville, TN (US); Ulrich Koss, Zoillkon (CH); Jalal Antranick Askander, Knoxville, TN (US)

(72) Inventors: Rameshwar S. Hiwale, Knoxville, TN (US); Ulrich Koss, Zoillkon (CH); Jalal Antranick Askander, Knoxville, TN (US)

(73) Assignee: ALSTOM TECHNOLOGY LTD, Baden (CH)

(21) Appl. No.: 13/434,092

(22) Filed: Mar. 29, 2012

(51) Int. Cl. B01D 19/00

(52) U.S. Cl. 95/16; 96/173

(57) ABSTRACT

A system and method for operating a stripper tower is disclosed. The temperature T_{M} of an aqueous solution is measured at a first elevation in the stripper tower. Temperature T_{C}, which corresponds to the temperature of saturated steam at the operating pressure of the stripper tower, is calculated. A temperature T_{OVER}, the difference between a temperature of an aqueous solution in the stripper tower subject to over stripping conditions and a temperature of an aqueous solution in the stripper tower subject to normal stripping conditions. The method further includes the step of adjusting a flow rate of saturated steam into the stripper tower so that T_{M} is substantially equivalent to the difference between T_{C} and T_{OVER}.

### FIELD OF THE DISCLOSURE

The present disclosure relates to a system and method for control of a stripper tower. More particularly, the present disclosure relates to a system and a method for adjusting the amount of saturated steam flowing into an ammonia stripper tower based on one or more temperature measurements in the stripper tower to inhibit under stripping conditions and/or to inhibit over stripping conditions.

### BACKGROUND OF THE DISCLOSURE

Stripping is a process in which a first component is separated from a second component based on a difference in the vapor pressure between the first component and the second component. An ammonia stripper tower, also referred to as an ammonia stripper column, can be used to separate ammonia from an aqueous solution comprising ammonia and water. The stripper tower can be a cylindrical column comprising a packing medium. The stripper tower includes an inlet for receiving the aqueous solution. The stripper tower further includes a vapor outlet near the top of the tower for exhausting ammonia vapor, and an underflow outlet near the bottom of the tower for exhausting aqueous solution. An inlet for receiving saturated steam (the stripping medium) is also provided in the stripping tower.

During operation of the ammonia stripper tower, the aqueous feed solution enters the tower and flows downward through the packing. Simultaneously, saturated steam is introduced in the bottom of the stripper tower and rises upward through the packing. As the aqueous solution flows through the packing, the aqueous solution is heated by the saturated steam. The heating vaporizes the ammonia in the aqueous solution. The vaporized ammonia flows upward in the stripper tower and exits through the vapor outlet. The remaining aqueous solution, which is not vaporized, continues to flow downward through the packing material and exits the stripper tower through the underflow outlet. Large differences in the vapor pressures of ammonia and water allow for a high degree of separation of ammonia and water in a stripper tower at relatively low operating pressure conditions. A properly calibrated stripper tower can separate substantially all of the ammonia from an aqueous feed stream as ammonia vapor and provide an aqueous underflow stream having a relatively low ammonia concentration.

Ammonia stripping can be used during the chilled ammonia process to enable reuse of ammonia in that process. The chilled ammonia process is used to remove carbon dioxide from flue gases generated during combustion, for example, in a coal fired boiler. The process results in an aqueous solution comprising water and ammonia. Ammonia stripping is used to separate the ammonia from the water. After separation, the ammonia is reused in the chilled ammonia process. The reuse of ammonia enabled by the stripping process reduces the cost of performing the chilled ammonia process because it reduces rate at which new ammonia must be added to perform the chilled ammonia process.

Under stripping is a condition that occurs during the stripping process when the amount of saturated steam provided to the stripper tower is not sufficient to strip substantially all of the ammonia from the aqueous solution. As a result, the concentration of ammonia in the aqueous underflow solution increases. Under stripping conditions decrease the efficiency of performing the chilled ammonia process because ammonia must be added to the system to account for the ammonia in the aqueous underflow solution that is not vaporized during the stripping process, and is therefore not available for reuse in the chilled ammonia process.

Over stripping is a condition that occurs when the amount of saturated steam provided to the stripper tower is more than sufficient to vaporize the ammonia in the aqueous feed solution. As a result the additional saturated steam, some of the water in the aqueous solution is also vaporized. During over stripping conditions, energy is expended to generate the saturated steam that vaporizes the water. This additional energy outlay increases the cost of performing the chilled ammonia process.

### SUMMARY OF THE DISCLOSURE

According to aspects illustrated herein, a method for operating a stripper tower is disclosed. The method includes the step of measuring a temperature T_{M} of an aqueous solution at a first elevation in the stripper tower. Temperature T_{C}, which corresponds to the temperature of saturated steam at the operating pressure of the stripper tower, is calculated. The method further includes the step of calculating a temperature T_{DELTA}. T_{DELTA} is the difference between a temperature of an aqueous solution in the stripper tower subject to over stripping conditions and a temperature of an aqueous solution in the stripper tower subject to normal stripping conditions. The method further includes the step of adjusting a flow rate of saturated steam into the stripper tower so that T_{M} is substantially equivalent to the difference between T_{C} and T_{DELTA}.

According to other aspects illustrated herein, a system for stripping ammonia from an aqueous solution is disclosed. The system includes a stripper tower having an inlet for receiving an aqueous solution and an inlet for receiving saturated steam. A first temperature sensor is configured to measure a temperature T_{M} of the aqueous solution at a first elevation in the stripper tower. The system includes a controller with software executing thereon. A first database contains a plurality of temperatures T_{C}, wherein each T_{C} corresponds to a temperature of saturated steam at an operating pressure of the stripper tower. A second database contains a plurality of temperatures T_{DELTA}, wherein each T_{DELTA} corresponds to a difference between a temperature of the aqueous solution in the stripper tower at the first elevation subject to over stripping conditions and a temperature of the aqueous solution in the stripper tower at the first elevation with normal stripping conditions. Software executing on the controller queries the first database by the operating pressure of the stripper tower to retrieve a T_{C}. Software executing on the controller queries the second database by the temperature of the aqueous solution in the stripper tower at the first elevation to retrieve a T_{DELTA}. Software executing on the controller generates a signal indicative of an adjustment of a flow rate of saturated steam into the stripper tower so that T_{M} is equivalent to the difference between T_{C} and T_{DELTA}.

### BRIEF DESCRIPTION OF THE DRAWINGS

FIG. 1 is a schematic drawing illustrating an ammonia stripper tower.

FIG. 2 is a chart of temperature profiles for use with the disclosed method and system.

FIG. 3 is a table of temperature and pressures of saturated steam for use with the disclosed system and method.

FIG. 4 is a chart of temperature profiles for use with the disclosed system and method.

FIG. 5 is a flow diagram illustrating a method of operating a stripper tower in accordance with the present disclosure.

### DESCRIPTION OF THE DISCLOSURE

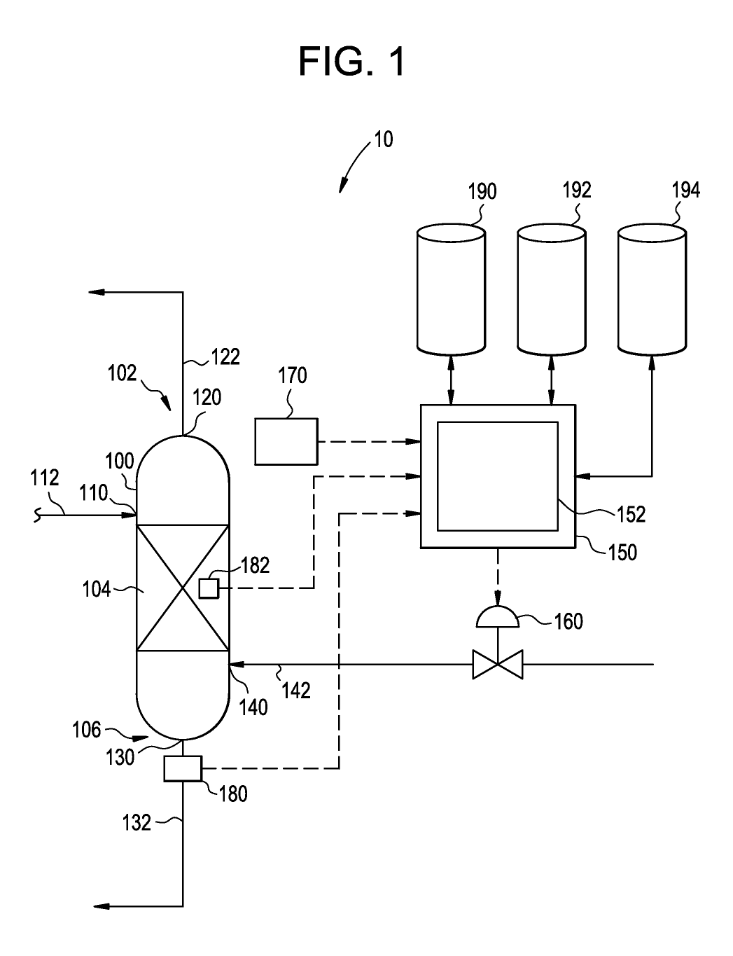

In FIG. 1, a system 10 for controlling a stripper tower 100 is shown. The stripper tower 100 extends between a top 102 and a bottom 106 and includes a packing medium 104 disposed therein. A first inlet 110 is provided for receiving an aqueous feed solution into the stripper tower 100. The first inlet 110 is in fluid communication with a conduit 112 for providing the aqueous solution. Throughout this disclosure, the term aqueous solution refers to the solution being treated in the stripper tower. The term aqueous feed solution refers specifically to the solution as it enters the stripper tower 100. Aqueous feed solution can also be referred to aqueous solution at the first inlet 100. The term aqueous underflow solution refers specifically to the aqueous solution as it exits the stripper tower 100. Aqueous underflow solution can also be referred to as aqueous solution at the underflow outlet 130 (which is described in more detail below).

It should be understood that although the disclosed system and method are described in relation to a specific embodiment of a stripper tower 100, the disclosed system and method are not limited in this regard. For example, the disclosed system and method can be adapted by a person of ordinary skill in the art to account for variations in the design of the stripper tower 100, the operating conditions of the stripper tower, and the properties of the aqueous solution being processed in the stripper tower, among other variables. To the extent specific dimensions, values, or specific operating conditions are included in this description, they are provided to broadly illustrate the system and method and are not intended to limit the scope of this disclosure.

In reference to FIG. 1, the inlet 110 for receiving the aqueous feed solution is located above the packing medium (also referred to as packing) 104 in the stripper tower 100. A second inlet 140 is provided for receiving saturated steam into the stripper tower 100. The second inlet 140 is in fluid communication with a conduit 142 for providing the saturated steam. In the embodiment shown, the second inlet 140 for receiving the saturated steam is located below the packing medium 104. As aqueous feed solution enters the stripper tower 100 through the first inlet 110 it flows downward through the packing material 104. Saturated steam enters the stripper tower 100 through the second inlet 140 and rises upward through the packing medium 104. The saturated steam transfers energy to the aqueous solution in the packing medium 104. At least a portion of the energy transferred to the aqueous solution causes at least a portion of the ammonia in the aqueous solution to vaporize. After vaporization, gaseous ammonia rises upward in the stripper tower 100. The portion of the aqueous solution that is not vaporized, including any unvaporized ammonia, continues to flow downward through the packing medium 104.

The stripper tower 100 includes a vapor outlet 120 near the top 102 of the stripper tower. The vapor outlet 120 is in fluid communication with a conduit 122 for receiving vapor generated during the stripping process. During operation, vaporized ammonia exits the stripper tower 100 via the vapor outlet 120. The stripper tower 100 includes an underflow outlet 130 near the bottom 106 of the stripper tower. The underflow outlet 130 is in fluid communication with a conduit 132 for receiving the aqueous solution the flows downward through the packing 104. During operation, aqueous solution that is not vaporized, including any unvaporized ammonia, exits the stripper tower 100 via the underflow outlet 130.

In reference to FIG. 1, the system includes a controller 150. The term controller 150, as used herein, generally refers to one or more devices capable of executing software. As can be appreciated by a person of ordinary skill in the art, many different devices are available for use as a controller 150. For example, one or more processor based computers can be used as a controller.

The saturated steam conduit 142 includes a valve 160 that can be adjusted between an open position and a closed position to vary the flow rate of saturated steam entering the stripper tower 100. The controller 150 is in communication with the valve 160. The system 10 includes software 152 executing on the controller 150 for generating a signal indicative of a setting for the valve 160 to achieve a desired flow rate of saturated steam into the stripper tower 100. The signal is transmitted from the controller 150 to the valve 160 and the valve is adjusted accordingly such that the flow rate of saturated steam into the stripper tower 100 corresponds to the generated signal. In this way, the system 10 can control the flow rate of saturated steam into the stripper tower 100.

The disclosed system 10 and method is capable of affecting the stripping conditions in the stripper tower 100 by controlling the flow rate of saturated steam into the stripper tower 100. For example, if under stripping conditions occur, the valve 160 can be controlled to increase the flow rate of saturated steam into the stripper tower 100, thereby inhibiting the under stripping conditions. If, for example, over stripping conditions occur in the stripper tower 100, the valve 160 can be controlled to decrease the flow rate of the saturated steam into the stripper tower 100, thereby inhibiting over stripping conditions. If, for example, normal stripping conditions occur, the valve 160 can be controlled to maintain the flow rate of saturated steam into the stripper tower 100, thereby maintaining normal stripping conditions.

The stripper tower 100 can be operated at a constant pressure. The specific constant pressure for operation depends on the type of stripper tower 100, the size of the stripper tower, the desired operation of the stripper tower, and the control of the stripper tower, among other variables. The operating pressure is typically in the range of 29 psig to 319 psig, although the operation of the stripper tower 100 is not limited in this regard and operating pressures for a stripper tower 100 may fall outside of this range.

The system 10 includes an interface 170 for inputting information indicative of the operating conditions of the stripper tower 100 into the controller 150. For example, the operating pressure of a stripper tower 100 can be input into the controller 150 via the interface 170. The interface 170 is in communication with the controller 150. Although the controller 150 and interface 170 are disclosed as separate elements in FIG. 1, the present disclosure is not limited in this regard. As can be appreciated by a person of ordinary skill in the art, the interface 170 may comprise a component of the controller 150. In yet other embodiments, it is not necessary to include an interface 170. In such embodiments, operating parameters for the stripper tower 100 can be programmed into the controller 150, or can be transmitted to the controller 150 by some other means. In yet other embodiments, the system 10 can include a pressure sensor (not shown in the Figures) that transmits a signal indicative of the operating pressure in the stripper tower 100 to the controller 150 in lieu of an interface.

The aqueous feed solution provided to the stripper tower 100 via the first inlet 110 has a specific ammonia content. In this description the ammonia content is generally provided as a molarity. The ammonia content of the aqueous feed solution depends on the upstream process, among other variables. The interface 170 enables a user to enter the ammonia content of the aqueous feed solution. During operation of the system 10 the aqueous underflow solution exiting the stripper tower 100 through the underflow outlet 130 typically has a target ammonia content. The actual ammonia content can vary based on the operating conditions of the stripper tower 100. The interface 170 enables a user to enter the target ammonia content of the aqueous solution exiting the stripper tower 100 through the underflow outlet 140. Although the system 10 is disclosed as having an interface 170 for receiving an input indicative of the ammonia content in the aqueous feed solution being provided to the stripper tower 100, or a target ammonia content in the aqueous underflow solution exiting the stripper tower 100 the present disclosure is not limited in this regard. For example, an alternative system in accordance with this disclosure may rely upon a sensor to detect the ammonia content of the aqueous feed solution flowing into the stripper tower 100 and transmit a signal indicative of that content to the controller 150.

The system 10 further includes a plurality of temperature sensors 180, 182 for measuring a temperature of the aqueous solution at specified points in and around the stripper tower 100. A first temperature sensor 180 is positioned near the underflow outlet 130 of the stripper tower 100. The first temperature sensor 180 is configured to measure a temperature of aqueous underflow solution exiting the stripper tower 100 via the underflow outlet 130. Although FIG. 1 indicates that the first temperature sensor 180 is on the outside of the stripper tower 100, positioned proximate to the underflow conduit 132, the present disclosure is not limited in this regard. For example, the first temperature sensor 180 can be positioned inside the stripper tower 100, among other positions. The first temperature sensor 180 transmits a signal indicative of the temperature of the aqueous underflow solution proximate to the first temperature sensor 180 to the controller 150.

The system 10 includes a second temperature sensor 182 positioned at a first elevation in the stripper tower 100. The second temperature sensor 182 is configured to measure a temperature of the aqueous solution in the packing medium 104 at the first elevation. Although not shown in FIG. 1, the disclosed system 10 is not limited to having one temperature sensor, i.e. the second temperature sensor 182, in the packing medium 104. For example, as can be appreciated by a person of ordinary skill in the art, the system 10 may include a plurality of temperature sensors positioned on the same elevation or on different level elevations in the packing medium 104. The second temperature sensor 182 transmits a signal indicative of the temperature of the aqueous solution proximate to the second temperature sensor 182 to the controller 150.

In reference to FIG. 1, the system 10 includes a first database 190 that is accessible by the controller 150. The first database 190 contains a plurality of temperatures T_{C}, wherein each T_{C} corresponds to the temperature of saturated steam at an operating pressure of the stripper tower 100. Software 152 executing on the controller 150 can query the first database 190 by an operating pressure of the stripper tower 100 to retrieve a corresponding T_{C}.

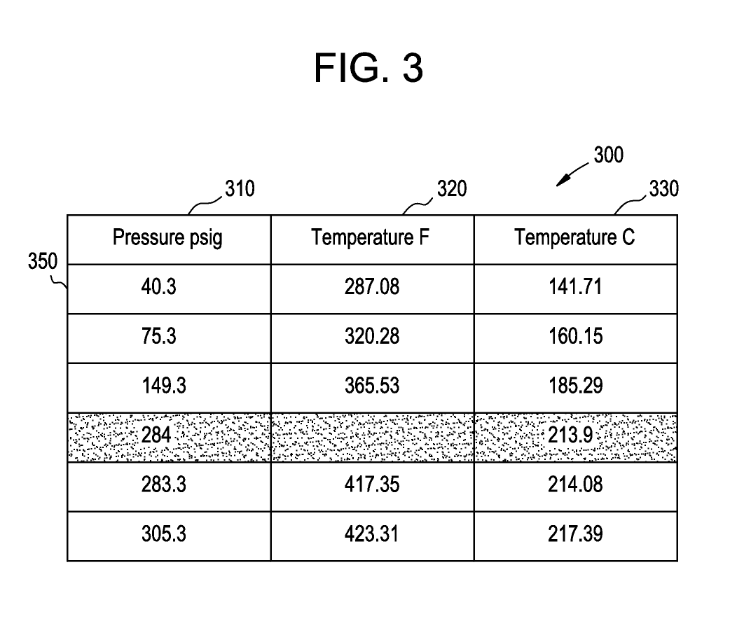

FIG. 3 is a table 300 generally illustrating a portion of the data structure of the first database 190. In the second column 320 there is a plurality of temperatures T_{C} in degrees Fahrenheit. In the third column 330, there is a plurality of temperatures T_{C} in degrees Celsius. In the first column 310, there is a plurality of pressures. Each T_{C} corresponds to an operating pressure of the stripper tower 100. For example, in reference to the second row 350 of table 300 the operating pressure in the first column 310 is 40.3 psig. This corresponds to a T_{C} in the second column 320 of the second row 350 of 287.08 F (141.71 C in third column 330 of the second row 350). For example, at an operating pressure of 40.3 psig, the table indicates that the temperature T_{C} of saturated steam is approximately 287.08 F. Thus, the table 300 can be used to determine the temperature T_{C} of saturated steam based on the operating pressure of the stripper tower 100. It should be understood that table 300 in FIG. 3 is provided to generally illustrate the structure of information in the first database 190 and is not intended to limit the disclosed system and method to the information included in the table 300.

In reference to FIG. 1, the system 10 includes a second database 192 that is accessible by the controller 150. The second database 192 contains a plurality of temperatures T_{DELTA}, wherein each T_{DELTA} corresponds to a difference between a temperature of the aqueous solution in the stripper tower 100 at the first elevation subject to over stripping conditions and a temperature of the aqueous solution in the stripper tower 100 at the first elevation subject to normal stripping conditions as determined at the operating pressure of the stripper tower and based on the ammonia content of the aqueous feed solution. Software 152 executing on the controller 150 queries the second database 192 by the operating pressure of the stripper tower 100 and by the ammonia content of the aqueous feed solution to retrieve a corresponding T_{DELTA}. In embodiments in which there is a plurality of temperature sensors at different elevations in the packing medium 104, the software 152 may additionally query the second database 192 by the elevation of one or more of the temperature sensors.

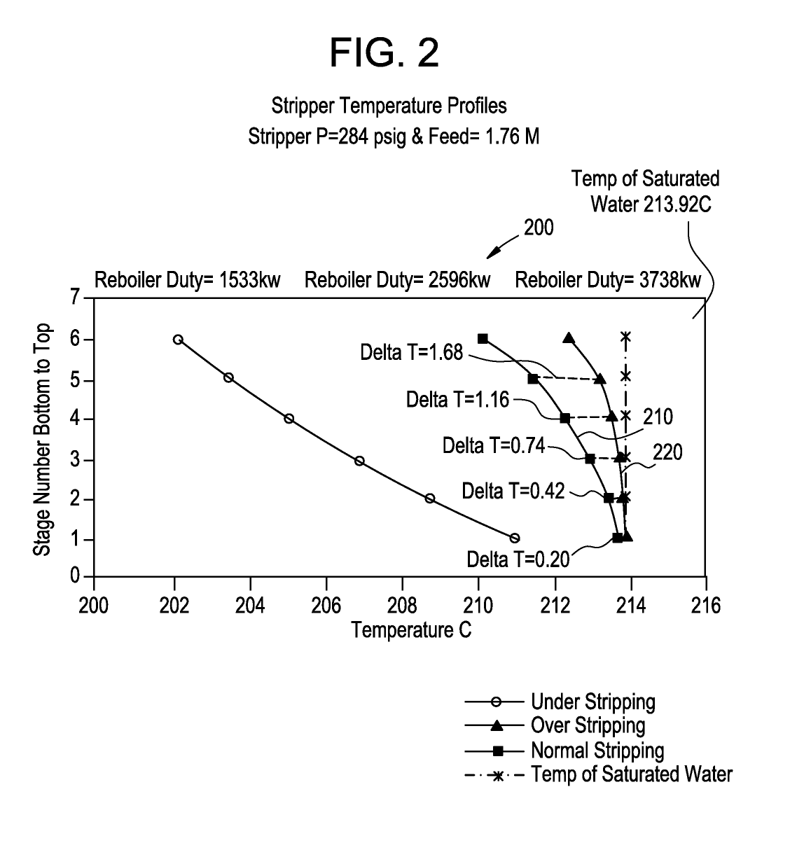

FIG. 2 is a chart 200 generally illustrating a portion of the data structure of the second database 192. The chart 200 includes temperature profiles of a stripper tower 100 receiving an aqueous feed solution having an ammonia content of 1.76 M and having an operating pressure of 284 psig. The x-axis of the chart is temperature. The y-axis of the is stage level, which corresponds to a specific height in the stripper column. In relevant part, a first trend line 210 illustrates the temperature of the aqueous solution at discrete elevations in the stripper tower 100 subject to normal stripping conditions. A second trend line 220 illustrates the temperature of the aqueous solution at the discrete elevations in the stripper tower 100 subject to over stripping conditions. The difference between the temperatures between the first trend line 210 and the second trend line 220 at a specific elevation corresponds to the T_{DELTA} at that specific elevation.

The information included in the second database 192 can be determined theoretically and/or experimentally. For example, the information can be determined theoretically using calculations based on the operating parameters of the stripper tower 100. The data can also be determined experimentally, for example, during calibration of the stripper tower 100. Additionally a combination of theoretic derivation and experimental measurement can be used to determine different T_{DELTA} for different elevations in a stripper tower, among other variables. It should be understood that the second database 192 includes a plurality of temperatures T_{DELTA} corresponding to different operating variables of the stripper tower 100, such as, for example, ammonia content of the aqueous feed solution. It should also be understood that chart 200 in FIG. 2 is provided to generally illustrate the structure of information in the second database 192 and it is not intended to limit the disclosed system and method to the information include in the chart 200.

In reference to FIG. 1, the system 10 includes a third database 194 that is accessible by the controller 150. The third database 194 contains a plurality of temperatures T₁, wherein each T₁ corresponds to a temperature of the aqueous underflow solution at the underflow outlet 130 having a specific ammonia content and at the operating pressure of the stripper tower 100. Software 152 executing on the controller 150 can query the third database 192 by an operating pressure and by an ammonia content of aqueous solution to retrieve a corresponding T₁.

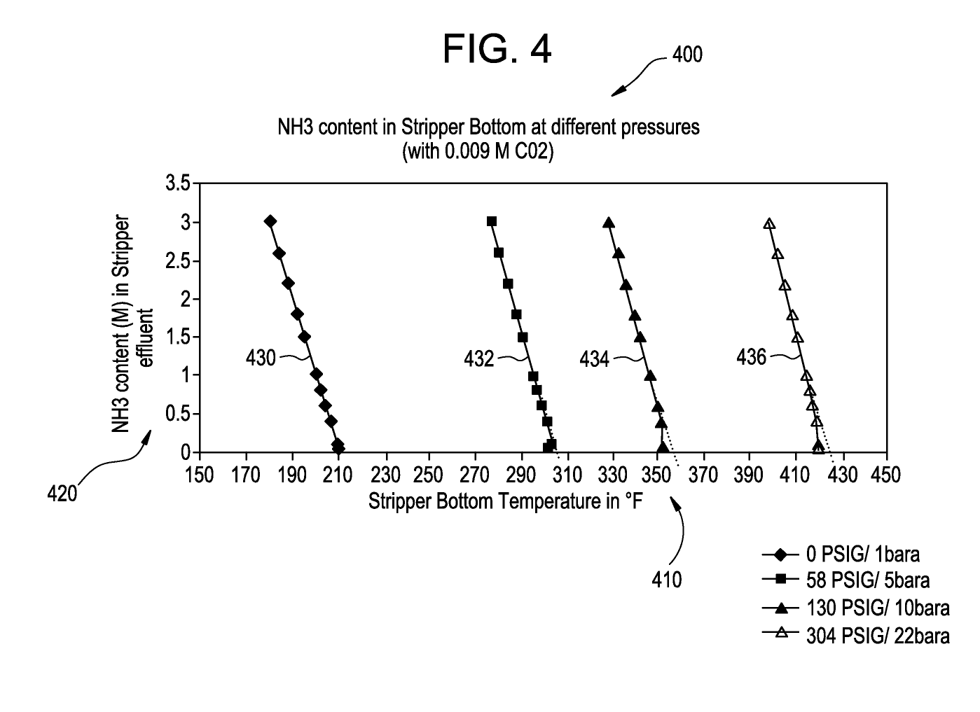

FIG. 4 is a chart 400 generally illustrating a portion of the data structure of the third database 194. The x-axis 410 corresponds to temperature at the bottom of the stripper tower 100. The y-axis 420 corresponds to ammonia content of the aqueous underflow solution flowing through the underflow outlet 130. Each trend line 430, 432, 434, 436 corresponds to a specific operating pressure of the stripper tower 100. Thus, using the chart 400 it is possible to determine a T₁ for an aqueous underflow solution having a specific ammonia content at the underflow outlet 130 in a stripper tower 100 at a specific operating pressure. For example, in a stripper tower 100 operating at 58 psig and having an aqueous underflow solution having an ammonia content of 1.5 M, T₁ corresponds to 290 F.

As with the second database 192, the data included in the third database 194 can be determined theoretically and/or experimentally. It should be understood that the third database 194 includes a plurality of temperatures T₁ corresponding to different operating variables of the stripper tower 100, such as, for example, different ammonia contents of the aqueous underflow solution exiting the stripper tower 100 at the underflow outlet 130 at different operating pressures of the stripper tower. It should also be understood that the chart 400 is for illustrative purposes and is not intended to limit the scope or volume of data included in third database 194.

During operation, the system 10 is capable of inhibiting under stripping conditions by adjusting the valve 160 to control the flow rate of saturated steam into the stripper tower 100 through the inlet 140. Under stripping conditions are inhibited by adjusting the valve 160 to control a flow rate of saturated steam into the stripper tower 100 so that T_{B} is substantially equivalent to the difference between T_{C} and T₁. The first temperature sensor 180 measures the temperature T_{B} of the aqueous underflow solution near the underflow outlet 130. The operating pressure of the stripper tower 100 is input into the controller 150 via the interface 170. Software 152 executing on the controller 150 queries the first database 190 by the input operating pressure to return a temperature T_{C} of saturated steam at the operating pressure of the stripper tower 100. The ammonia content of the aqueous underflow solution exiting the stripper tower 100 at the underflow outlet 130 is input into the controller 150 via the interface 170. Software 152 executing on the controller queries the third database 194 by the input ammonia content and by the input operating pressure to retrieve a temperature T₁. Software 152 executing on the controller 160 generates a signal indicative of an adjustment of a flow rate of saturated steam into the stripper tower 100 at the inlet 140 so that T_{B} is substantially equivalent to the difference between T_{C} and T₁. The signal indicative of the adjustment of the flow rate is transmitted to the valve 160 and the valve is adjusted to control the flow rate of saturated steam accordingly. This process can be repeated so that T_{B} is substantially equivalent to the difference between T_{C} and T₁ during operation of the stripper tower 100 thereby inhibiting under stripping conditions.

During operation, the system 10 is capable of inhibiting over stripping conditions by adjusting the valve 160 to control the flow rate of saturated steam into the stripper tower 100 through the inlet 140. Over stripping conditions are inhibited by adjusting the valve 160 to control a flow rate of saturated steam into the stripper tower 100 so that T_{M} is substantially equivalent to the difference between T_{C} and T_{DELTA}. The second temperature sensor 182 measures the temperature T_{M} of the aqueous solution at a first elevation in the packing. The operating pressure is input into the controller 150 via the interface 170. Software 152 executing on the controller 160 queries the first database 190 by the inputted operating pressure to return a temperature T_{C}, wherein T_{C} corresponds to the temperature of saturated steam at the operating pressure of the stripper tower 100. The content of ammonia of the aqueous feed solution entering the stripper tower 100 at the inlet 110 is input into the controller 150 via the interface 170. Software 152 executing on the controller queries the second database 192 by the inputted content of the ammonia and by the inputted operating pressure to retrieve a temperature T_{DELTA}. Software 152 executing on the controller 160 generates a signal indicative of an adjustment of a flow rate of saturated steam into the stripper tower 100 at the inlet 140 so that T_{M} is substantially equivalent to the difference between T_{C} and T_{DELTA}. The signal indicative of the adjustment of the flow rate is transmitted to the valve 160 and the flow rate of saturated steam is adjusted accordingly. This process can be repeated so that T_{M} is substantially equivalent to the difference between T_{C} and T_{DELTA} during operation of the stripper tower 100 thereby inhibiting over stripping conditions.

It should be understood that the described method and system for inhibiting over stripping and for inhibiting under stripping is provided for illustrative purposes only and is not intended to limit the disclosure. For example, the method and system for inhibiting over stripping can use a plurality of temperature sensors, wherein each temperature sensor is positioned at a different elevation in the packing tower. The controller can subsequently determine an appropriate T_{DELTA} for each elevation based on the operating conditions of the stripper tower. In other embodiments, the control process for inhibiting under stripping and the control process for inhibiting over stripping are performed in a serial manner. For example, the control process for inhibiting under stripping is performed during the start up of a stripper tower. After it is determined that T_{B} is substantially equivalent to the difference between T_{C} and T₁, the control process for inhibiting over stripping is implemented.

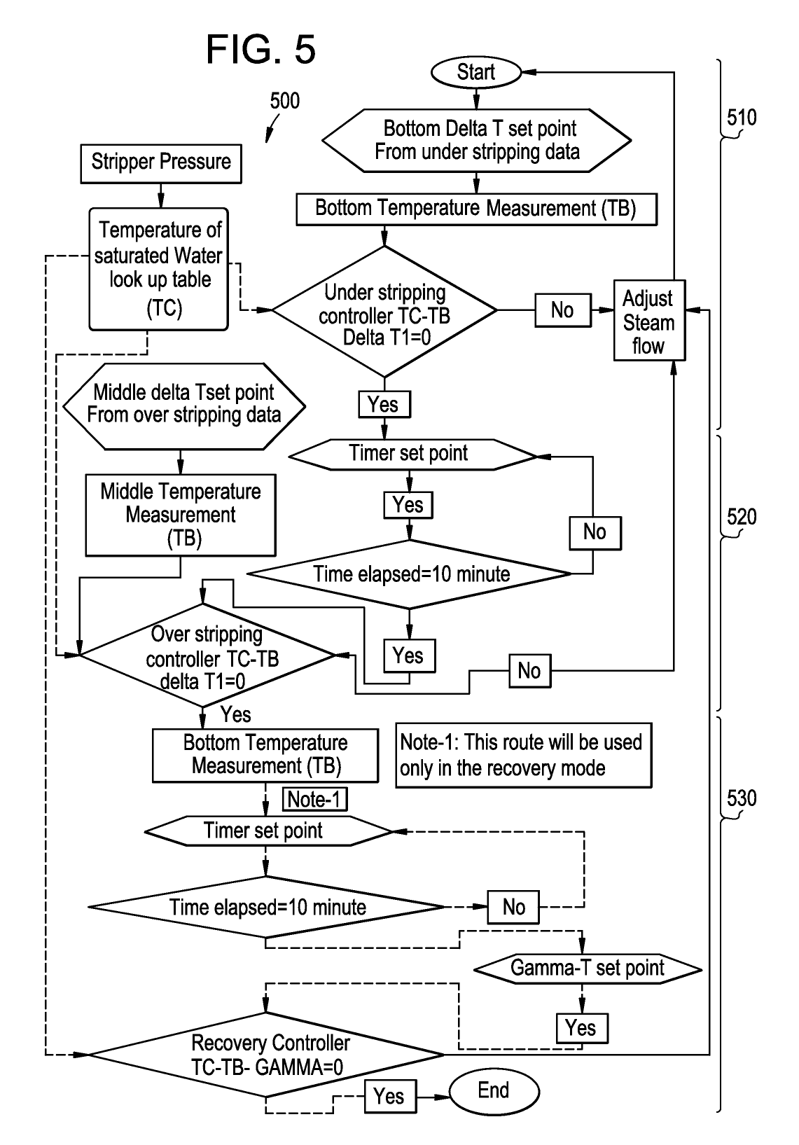

FIG. 5 is a flow diagram illustrating a method 500 of operating a stripper tower in accordance with the present disclosure. It should be understood that FIG. 5 illustrates one method of operating a stripper tower and is not intended to limit the present disclosure. A first portion 510 of the flow diagram 500 illustrates the method to inhibit under stripping as described above. A second portion 520 of the flow diagram illustrates the method to inhibit over stripping as described above. A third portion 530 of the flow diagram illustrates a recovery stage that can be implemented with the stripper tower.

Although the present disclosure has been described with reference to certain embodiments thereof, it should be noted that other variations and modifications may be made, and it is intended that the following claims cover the variations and modifications within the true scope of the disclosure.

What is claimed is:

1. A method of operating a stripper tower comprising the steps of:
measuring a temperature T_{M} of an aqueous solution at a first elevation in a stripper tower;
determining a temperature T_{C}, wherein T_{C} is the temperature of saturated steam at an operating pressure of the stripper tower;
determining a temperature T_{DELTA}, wherein T_{DELTA} is the difference between a temperature of an aqueous solution in the stripper tower subject to over stripping conditions and a temperature of an aqueous solution in the stripper tower subject to normal stripping conditions;
adjusting a flow rate of a saturated steam into the stripper tower so that T_{M} is substantially equivalent to the difference between T_{C} and T_{DELTA}.

2. The method of claim 1, wherein the stripper tower is configured as an ammonia stripper tower.

3. The method of claim 2, wherein the stripper tower is adapted to receive an aqueous solution used during a chilled ammonia carbon dioxide capture process.

4. The method of claim 3, wherein the first elevation is below an inlet in the stripper tower for receiving the aqueous solution.

5. The method of claim 1, wherein the T_{C} is calculated using a first database containing a plurality temperatures T_{C}, wherein each T_{C} corresponds to the temperature of saturated steam at an operating pressure of the stripper tower.

6. The method of claim 5, wherein T_{DELTA} is calculated using a second database containing a plurality of temperatures T_{DELTA}, wherein each T_{DELTA} corresponds to a temperature of the aqueous solution in the stripper tower at the first elevation.

7. The method of claim 6, wherein each T_{DELTA} further corresponds to an ammonia content in the aqueous solution when it enters the stripper tower.

8. The method of claim 7, wherein each T_{DELTA} further corresponds to an operating pressure of the stripper tower.

9. A method of operating a stripper tower comprising the steps of:
measuring a temperature T_{B} of an aqueous solution at a bottom of the stripper tower;
determining a temperature T_{C} of saturated steam based on an operating pressure of the stripper tower;
determining a temperature T₁, wherein T₁ is the temperature of the aqueous solution exiting the stripper tower at an underflow outlet having a specific ammonia content at the underflow outlet and in a stripper tower having a specific operating pressure;
adjusting a flow rate of saturated steam into the stripper tower so that T_{B} is substantially equivalent to the difference between T_{C} and T₁.

10. The method of operating a stripper tower according to claim 9, further comprising the steps of:
performing the steps of claim 1 after T_{B} is substantially equivalent to the difference between T_{C} and T₁.

11. A system for stripping ammonia from an aqueous solution, the system comprising:
a stripper tower having an inlet for receiving an aqueous solution and an inlet for receiving saturated steam;
a first temperature sensor configured to measure a temperature T_{M} of the aqueous solution at a first elevation in the stripper tower;
a controller;
a first database containing a plurality temperatures T_{C}, wherein each T_{C} corresponds to the temperature of saturated steam at an operating pressure of the stripper tower;
a second database containing a plurality of temperatures T_{DELTA}, wherein each T_{DELTA} corresponds to a difference between a temperature of the aqueous solution in the stripper tower at the first elevation subject to over stripping conditions and a temperature of the aqueous solution in the stripper tower at the first elevation subject to normal stripping conditions;
software executing on the controller for querying the first database by the operating pressure of the stripper tower to retrieve a T_{C},
software executing on the controller for querying the second database by the temperature of the aqueous solution in the stripper tower at the first elevation to retrieve a T_{DELTA},
software executing on the controller for generating a signal indicative of an adjustment of a flow rate of saturated steam into the stripper tower so that T_{M} is substantially equivalent to the difference between T_{C} and T_{DELTA}.

12. The system of claim 11, wherein the aqueous solution received in the inlet comprises ammonia.

13. The system of claim 12, wherein the stripper tower is adapted to receive an aqueous solution used during a chilled ammonia carbon dioxide capture process.

14. The system of claim 13, wherein the first elevation is below the inlet in the stripper tower for receiving the aqueous solution.

15. The system of claim 14, wherein each T_{DELTA} further corresponds to a content of ammonia in the aqueous solution entering the stripper tower.

16. The system of claim 15, wherein each T_{DELTA} further corresponds to an operating pressure of the stripper tower.

17. The system of claim 11, further comprising:
a second temperature sensor configured to measure a temperature T_{B} of the aqueous solution at a bottom of the stripper tower;
a third database containing a plurality of temperatures T₁, wherein each T₁ corresponds to the temperature of an aqueous solution at the bottom of the stripper tower having a specific ammonia content and at the operating pressure of the stripper tower;
software executing on the controller for determining a flow rate of saturated steam into the stripper tower so that T_{B} is substantially equivalent to the difference between T_{C} and T₁.

18. A system for stripping ammonia from an aqueous solution, the system comprising:
a temperature sensor configured to measure a temperature T_{B} of the aqueous solution at a bottom of the stripper tower;
a first database containing a plurality temperatures T_{C}, wherein each T_{C} corresponds to the temperature of saturated steam at an operating pressure of the stripper tower;
a second database containing a plurality of temperatures T₁, wherein each T₁ corresponds to the temperature of an aqueous solution at the bottom of the stripper tower having a specific ammonia content and at the operating pressure of the stripper tower;
software executing on the controller for determining a flow rate of saturated steam into the stripper tower so that T_{B} is substantially equivalent to the difference between T_{C} and T₁.
